(19) United States
(12) Patent Application Publication
(10) Pub. No.: US 2023/0360173 A1
(43) Pub. Date: Nov. 9, 2023

(54) CONTENT-AWARE BIFURCATED UPSCALING

(71) Applicant: QUALCOMM Incorporated, San Diego, CA (US)

(72) Inventors: Qingqing GAI, Shanghai (CN); Hhao ZHANG, Shanghai (CN); Xun JIANG, Shanghai (CN); Rui ZOU, Pudong New Area (CN)

(21) Appl. No.: 18/245,437

(22) PCT Filed: Dec. 3, 2021
(86) PCT No.: PCT/CN2021/135292

§ 371 Date: Mar. 15, 2023

(30) Foreign Application Priority Data
Dec. 3, 2020 (WO) PCT/CN2020/133510

(51) Int. Cl. G06T 3/40; G06V 30/19

(52) U.S. Cl. CPC G06T 3/4046; G06V 30/19127

(57) ABSTRACT

Certain aspects of the present disclosure provide a method, including: receiving input image data in a first resolution, wherein the input image data comprises text data and graphic data; generating scaled graphic data at a second resolution based on the graphic data at the first resolution and a first scaling factor, wherein the second resolution is based on the first resolution and the first scaling factor; generating scaled text data based on the text data and a second scaling factor; and generating output image data in the second resolution based on the scaled text data and the scaled graphic data.

### CROSS-REFERENCE TO RELATED APPLICATIONS

This application claims priority to PCT application serial number PCT/CN2020/133510, entitled “Content-Aware Bifurcated Upscaling”, filed Dec. 3, 2020, and assigned to the assignee hereof, the contents of which are hereby incorporated by reference in their entirety.

### INTRODUCTION

Aspects of the present disclosure relate to systems and methods for upscaling computer-generated content, and in particular to performing content-aware bifurcated upscaling of image content.

Super-resolution (SR) is generally a process of upscaling, and in some cases improving, the details within an image. For example, a low resolution image may be used as an input to a model that outputs an upscaled version of the same image at a higher resolution. The model may be trained to generate the additional details in the high resolution output, and may generally be referred to as an upscaling or an SR model.

While SR models may generally be trainable to upscale input image data from a lower resolution to a higher resolution, not all image content within the image data takes is equally amenable to upscaling. For example, using SR models to upscale textual content, such as numbers, characters, symbols, and the like, may result in artifacts, blurriness, distortions, or other noticeable irregularities after upscaling that are easily identified by a human viewer. In a worst-case scenario, upscaled textual content may not appear to be textual content at all. In many other scenarios, upscaled textual content may include incorrect characters or other errors that, while recognizable as textual content, may be nonsensical or otherwise include typographical errors. Consequently, when upscaling image data that includes textual elements, many SR models fail to produce an acceptable output. This problem is particularly acute in the domain of mobile devices, which may have high-resolution screens capable of displaying high-resolution image data, but which also have significant power usage and data transmission considerations and thus may need to make greater use of upscaling processes to reduce the amount of data received by these devices and thus reduce the amount of time in which power-intensive components, such as radio frequency (RF) components, antennas, baseband processors, etc. are active.

Accordingly, what are needed are systems and methods for performing content-aware upscaling that improves the quality of the textual and non-textual image content alike.

### BRIEF SUMMARY

Certain aspects provide a method, including: receiving input image data in a first resolution, wherein the input image data comprises text data and graphic data; generating scaled graphic data at a second resolution based on the graphic data at the first resolution and a first scaling factor, wherein the second resolution is based on the first resolution and the first scaling factor; generating scaled text data based on the text data and a second scaling factor; and generating output image data in the second resolution based on the scaled text data and the scaled graphic data.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIGS. 1A and 1B depict examples of upscaled image data.

FIG. 2 depicts aspects of a method for performing content-aware bifurcated upscaling.

FIG. 3 depicts an example implementation of a textual content process.

FIG. 4 depicts an example method for generating upscaled scenes using content-aware bifurcated upscaling.

FIG. 5 depicts an example processing system that may be configured to perform the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for performing content-aware bifurcated upscaling of image data.

Image data, such as that generated by many types of computer-based applications, may comprise various types of content, including shapes representing various objects, structures, patterns, backgrounds, scenery and the like, as well as textual content, such as numbers, characters, symbols, symbolic characters, logograms, and the like.

Conventional model-based upscaling, including conventional super resolution (SR) methods that recover a high resolution image from a low resolution input image, treats all content in the image data (e.g., all pixels in an image) alike during upscaling. However, such conventional content-unaware upscaling processes may lead to mixed results as viewers may be more sensitive to upscaling artifacts, such as blurriness, distortions, or other noticeable irregularities, for textual content as compared to non-textual content. Consequently, many upscaling models fail to produce an acceptable output when upscaling image data including textual content. For example, these upscaling models may produce content that is not recognizable as textual content or may produce content including erroneous characters in the upscaled image data.

In order to overcome shortcomings with conventional upscaling methods, aspects of the present disclosure bifurcate the processing of different content types within underlying image data. More specifically, aspects of the present disclosure may receive and/or extract textual content from input image data and process the received and/or extracted textual content separately from the input image data using a lossless or lower loss upscaling process. The remaining non-textual content in the input image data may then be processed using a model-based upscaling or super resolution model. The results of the bifurcated processing may then be recombined to form upscaled output image data that maintains higher fidelity of the textual content compared to conventional methods. Thus, aspects of the present disclosure implement a content-aware upscaling process.

In some cases, the textual content may be directly received from an underlying process or application (e.g., a game engine) that creates image data and embedded textual content. For example, a user interface layer or component of an application may generate textual content for embedding in an output data stream, and this UI layer or component may be configured to provide the textual data directly to a textual content processing component for upscaling.

In other cases, the textual content may be identified within the image data generated by an application, such as by using optical character recognition (OCR) or other detection methods. Once detected, the textual content may then be extracted and processed separately from the non-textual content in the image data.

Whether the textual content is received directly, e.g., from the application, or extracted, e.g., from application image data output, the textual content may be converted to and/or stored in a vector format and upscaled in a lossless (or lower loss) manner so that it may be subsequently integrated back into upscaled non-textual image data. Generally, a vector format may represent graphical data as a set of statements describing the placement of lines or shapes in the graphical data in mathematical terms. Because the graphical data in a vector format is described in mathematical terms, graphical data in a vector format can be upsized and downsized with minimal to no loss of graphical fidelity. This is in contrast to textual content received in a raster format, which describes graphical data in terms of pixels on a grid and for which resizing generally entails some degree of interpolation (or estimation) for each pixel in a source image. Because resizing raster graphics may involve some degree of interpolation or estimation, resizing raster graphics may result in the introduction of artifacts into the resized image data, such as artifacts which may transform textual content into content that is not recognizable as textual content or introduce typographical errors into the resized textual content.

One technique for upscaling of non-textual image data may include using a trained neural network model to generate upscaled image data from source image data. For example, a deep neural network, such as a generative adversarial network (GAN), residual (or recurrent) neural network (RNN), convolutional neural network (CNN), and others, may be trained to take as input a low resolution image and to output a higher resolution (e.g., upscaled) image, and thereby to perform a super-resolution process.

The upscaled textual and non-textual content may then be recombined into a final upscaled result (e.g., image) that has higher overall fidelity than conventional methods. For example, textual content in the final upscaled result may be recognizable as textual content and may include the same characters as the textual content in the source image data generated by the application. Moreover, the use of neural network-based upscaling models to upscale the non-textual content may provide significant processing advantages for the underlying lower resolution image data, which may speed up application processing for the underlying image data without sacrificing fidelity of the upscaled output. For example, game engines may beneficially generate frames at a higher rate (e.g., provide more frames of image data per second) by processing the underlying image data at lower resolutions (and thus at lower computational complexity) and then upscaling the output to a higher resolution image for viewing by a user.

### Example Loss of Fidelity with Content-Unaware Upscaling

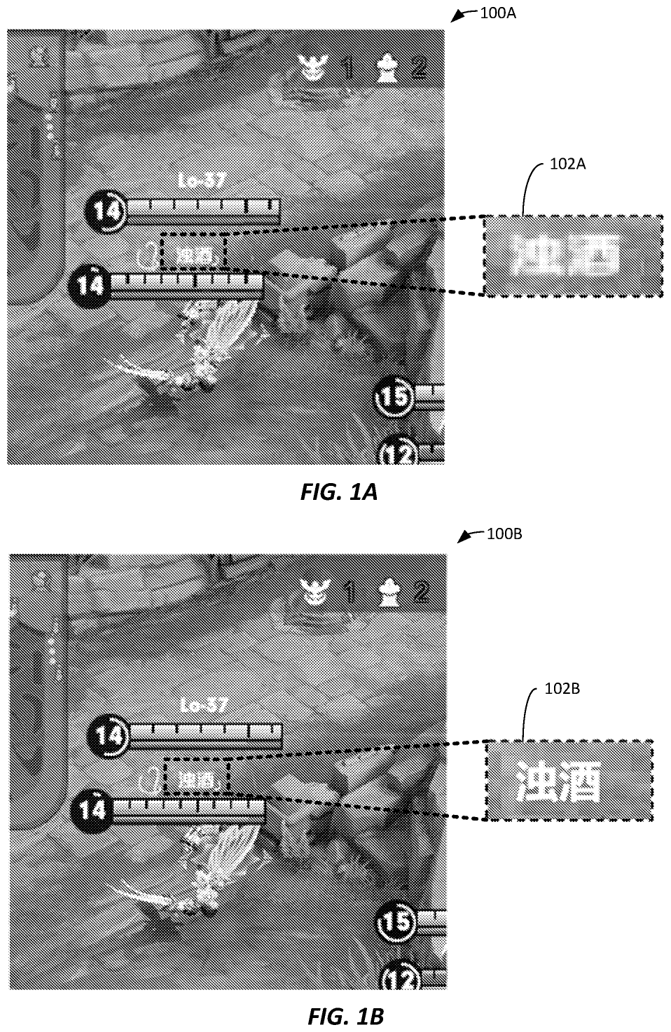

FIG. 1A depicts an example of an upscaled image 100A including textual and non-textual content. For example, the non-textual content, which may be referred to generally as graphic content or scene content, includes the background scenery, objects in the scene, and the like. The textual content includes the numbers, letters, and logograms in this example.

In the depicted example, image 100A has been upscaled using a non-content aware upscaling process, such as a super resolution model applied to the image data as a whole. Notably, textual content 102A (logograms in this example) is shown in a breakout box to demonstrate how the upscaling of image 100A has negatively affected the fidelity of the textual content as compared to the ground truth textual content 102B shown with respect to FIG. 1B. By contrast, other non-textual aspects of upscaled image 100A, such as the background, objects, and the like, have significantly better fidelity and more closely match the ground truth image 100B of FIG. 1B.

### Content-Aware Bifurcated Upscaling

As discussed, to allow for image data to be upscaled while maintaining the fidelity of certain content, such as textual content, aspects of the present disclosure may bifurcate upscaling based on the content present in different portions of input image data. Non-textual image data or other image data that is amenable to upsizing using deep neural networks can be upscaled separately from textual data or other data in the input image data that may not be amenable to upsizing using these deep neural networks. To maintain the fidelity of the textual data or other data in the image, this data may be upsized using lossless or near-lossless techniques such that the textual data or other data included in the input image data and the upsized image data are the same content at different resolutions.

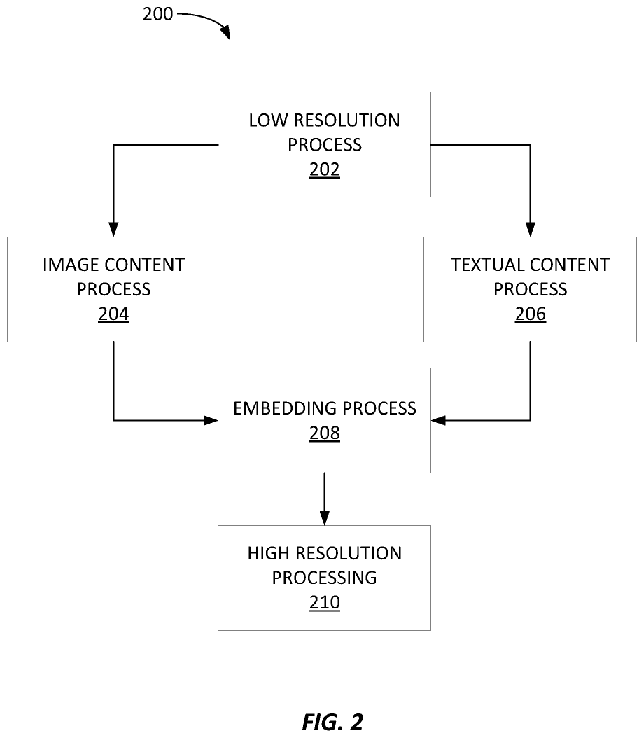

FIG. 2 depicts aspects of a method 200 for performing content-aware bifurcated upscaling. As discussed, content-aware bifurcated upscaling may allow for content that is less sensitive to artifacts generated in the upsizing process to be upscaled using different techniques from those used to upscale content that is more sensitive to artifacts generated in the upsizing process. In this manner, textual content (or other content that is sensitive to artifacts) can be upsized using techniques that allow for the fidelity of the textual content to be maintained at any resolution to which the input image data is upscaled.

Method 200 begins with low resolution process 202. Low resolution process 202 may include, for example, a game engine that processes image data (e.g., game scenery) in a first, lower resolution to improve processing speed (e.g., to generate a higher frame rate of output image data). As another example, low resolution process 202 may include a data transmission step in which image data at a first, higher resolution is received and image data at a second, lower resolution is generated for transmission to save bandwidth. These are just a few examples, and many others exist. Generally, low resolution process 202 may refer to any processing scenario in which underlying data may be processed at a lower resolution than the intended ultimate output data in order to enhance the speed of the processing, reduce the amount of data transmitted by or received at a device, and the like.

Low resolution process 202 outputs image data to image content process 204, which in various aspects may comprise a model configured to take the input image data in the first, lower resolution, and output the image data in a second, higher resolution. In some cases, the ratio of the higher output resolution to the lower input resolution may be considered a scaling factor. Notably, in this example, “low” and “high” are relative terms, which may refer to any relatively lower and relatively higher resolutions.

In some aspects, image content process 204 comprises a neural network model, such as a deep neural network model. In some cases, the neural network model may comprise a generative adversarial network (GAN), residual (or recurrent) neural network (RNN), convolutional neural network (CNN), and others. In some aspects, image content process 204 may comprise a neural network model configured to perform super resolution.

Note that image content process 204 may receive low resolution input data that includes textual content, such as where an application outputs image data embedded with textual and non-textual aspects. However, as described above, image content process 204 may not be configured to specifically process the textual content so that it maintains high fidelity after upscaling.

Image content process 204 outputs upscaled image content to embedding process 208. The upscaled image content may include static images, moving or sequential images forming a part of a video, and the like.

In some cases, the low resolution input data received by image content process 204 may include multi-layered image data. Such data may be processed, in some aspects, sequentially, layer-by-layer. Alternatively, where image content process 204 is implemented by a model capable of multi-layer processing, such as a neural network model, the multi-layer input data may be processed in parallel.

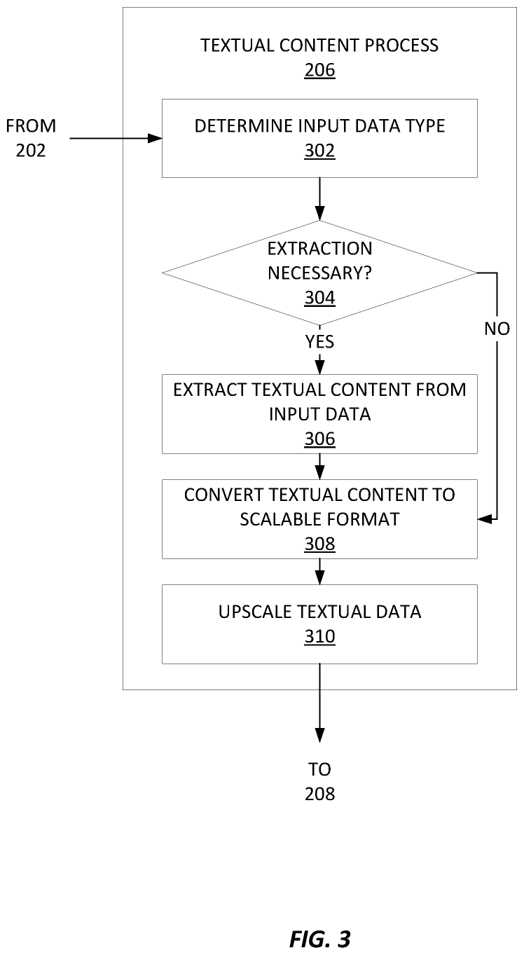

Low resolution process 202 further outputs image data comprising textual content, or textual content directly, to textual content process 206. As described in further detail below with respect to FIG. 3, textual content process 206 either receives or extracts the textual content and performs a lossless or otherwise high-fidelity upscaling to the textual content. For example, the textual content may be received in or extracted and converted to a vector format so that high fidelity upscaling can be performed.

In some aspects, textual content process 206 is configured to upscale the textual data based on a scaling factor applied to by image content process 204, such as a 2× or 3× scaling factor. These scaling factors are just examples, and any numerical scaling factor is possible.

Textual content process 206 outputs upscaled textual content to embedding process 208.

Embedding process 208 receives the upscaled image content from image content process 204 and the upscaled textual content from textual content process 206 and embeds (or combines) the inputs to generate a high resolution output (e.g., a high resolution image data output).

In some cases, where textual content process 206 receives the same image data as image content process 204 and extracts the textual content from the image data (as described further below with respect to FIG. 3), the location of the extracted textual content is stored so that embedding process 208 can embed the upscaled textual content in the correct location. This may include a location translation based on the lower and higher resolutions. Further, in some cases, this may include overwriting lower-fidelity textual content that was upscaled via image content process 204 (because it was part of the same underlying image data). Accordingly, in some aspects, embedding process 208 may include a trained model to repair any artifacts of the overwriting of higher fidelity textual content from textual content process 206 on lower fidelity textual content from image content process 204.

The embedded high resolution output is then provided to high resolution process 210. In one example, high resolution process 210 is a graphics rendering component that takes the high resolution output and displays it on a display device for a user. For example, high resolution process 210 may take high resolution game image data and display it on a display device of a mobile device, such as a smart phone, tablet computer, smart wearable device, or the like. Notably, these are just some examples, and many others are possible.

In some aspects, the scaling factor for image content process 204 and textual content process 206 may be based on a ratio of the resolution capability of the end use device, e.g., a mobile device's screen resolution, and may be set dynamically based on the device upon which image content process 204 and textual content process 206 are implemented. In this way, the low resolution process 202, image content process 204, and textual content process 206 may be modular to different devices and platforms, and may be dynamically configured for a high resolution process 210 based on the device type and capabilities. In some cases, low resolution process 202 may be configured to process data at a resolution that is a ready multiple of many common display resolutions.

In some aspects, the image content and the textual content may be scaled at different scaling factors. For example, the pixel density of the display on which the embedded high resolution output is displayed may be used to determine the scaling factor for the image content. As the pixel density of the display increases, the scaling factor for the textual content may also increase so that the text is rendered in the high resolution output at an acceptable size for display. Notably, this is just an example, and many other considerations may be used to determine the scaling factors used for upscaling the image content and the textual content.

Thus, FIG. 2 demonstrates a bifurcated content-aware upscaling method wherein image content processing is bifurcated from textual content processing and the resulting upscaled data is recombined to form a high fidelity upscaled output. By bifurcating upscaling of image data based on the content being upscaled, aspects of the present disclosure (such as that illustrated in FIG. 2) generally allow for small amounts of data to be generated by time-sensitive applications (e.g., game engines or other computational processes that are intended to generate data as quickly as possible) or to be transmitted to a receiving device, and for larger amounts of data to be recovered. Further, in recovering these larger amounts of data, the quality of the content included in these larger amounts of data may be maintained so that content that is generally not amenable to upscaling using super resolution models is upsized using other techniques that preserve the fidelity of such data. Thus, aspects of the present disclosure may allow for upscaling of content that preserves the fidelity of such content while allowing for power-intensive processes, such as data generation or data reception, to be less computationally complex, take less time to execute, and consume less power.

### Multi-Model Textual Content Processing

FIG. 3 depicts an example implementation of a textual content process 206, such as described with respect to FIG. 2.

In the depicted example, textual content process 206 starts at 302 with determining an input data type, such as may be received from low resolution process 202 in FIG. 2.

In order to be flexibly implemented, textual content process 206 may be configured to handle multiple input data types (e.g., to perform multi-model textual content processing). For example, at step 302, textual content process 206 may determine whether the input is direct text content (e.g., numbers, characters, letters, etc. provided in a text format) as may be provided by a content component of an application (e.g., a user interface component of an application), or image data comprising textual content. In some cases, where the input data type is image data, it may be the same image data provided to image content process 204.

Textual content process 206 then determines based on the input data type (e.g., text data or image data including text data) whether or not text extraction is necessary at step 304.

If at step 304, it is determined the textual content extraction is necessary, then textual content process 206 moves to step 306 where the textual content is extracted. For example, in one aspect, an OCR process may be performed on input image data to identify and extract the textual content. In other aspects, other types of text recognition and extraction may be performed, such as by other types of trained models. After the textual content is extracted, textual content process 206 moves to step 308.

If at step 304, it is determined the textual content extraction is not necessary, such as when textual by is directly provided from low resolution process 202, then textual content process 206 moves directly to step 308.

At step 308, then textual content process 206 converts the textual content into a lossless or low-loss scalable format. For example, the textual content may be converted into a vector format that may be losslessly scaled.

At step 310, textual content process 206 upscales the textual content. For example, the upscaling may be performed based on a scaling factor, such as described above.

Finally, then textual content process 206 provides the upscaled textual data to an embedding (or combining) process, such as embedding process 208 described with respect to FIG. 2.

### Example Method for Generating Upscaled Scenes Using Content-Aware Bifurcated Upscaling

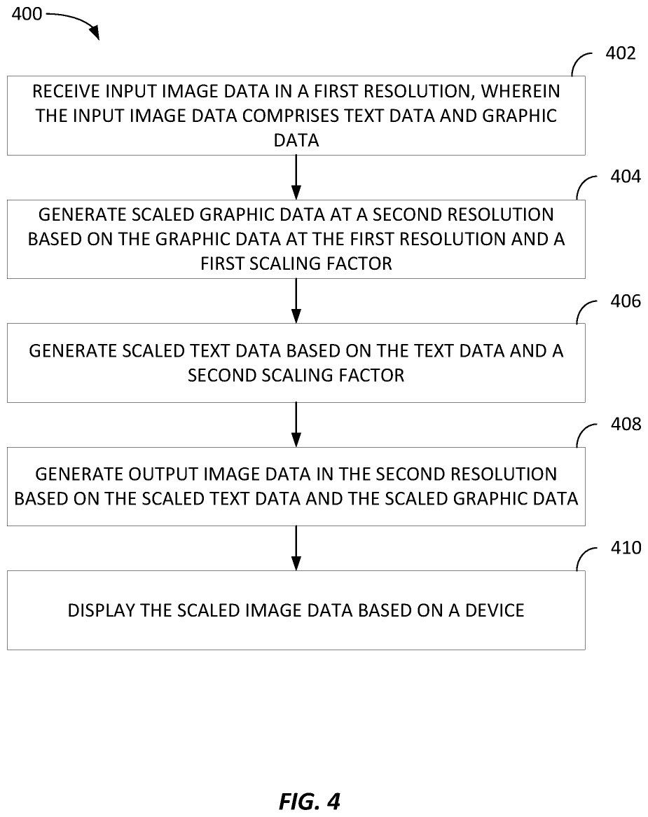

FIG. 4 depicts an example method 400 for generating upscaled scenes using content-aware bifurcated upscaling, as described with respect to FIGS. 2 and 3.

Method 400 begins at step 402 with receiving input image data in a first resolution, wherein the input image data comprises text data and graphic data. For example, as described with respect to FIGS. 1A and 1B, the text data may include numbers, letters, logograms, and the like, and the graphic data may include scene content, such as background scenery, objects in the scene, and the like.

Method 400 then proceeds to step 404 with generating scaled graphic data at a second resolution based on the graphic data at the first resolution and a first scaling factor. The second resolution may be based on the first resolution and the first scaling factor. For example, the second resolution may be the product of the first resolution and the first scaling factor, such that the second resolution substantially matches the resolution of a device on which the upscaled version of the input image data is to be displayed. In some aspects, the scaled graphic data may be generated via a model, such as described above with respect to image content process 204 of FIG. 2.

Method 400 then proceeds to step 406 with generating scaled text data based on the text data (received as part of the input image data) and a second scaling factor.

In some aspects of method 400, the second scaling factor is determined by a ratio of the second resolution to the first resolution. In some aspects, the first resolution is lower than the second resolution.

Method 400 then proceeds to step 408 with generating output image data in the second resolution (e.g., upscaled output image data) based on the scaled text data and the scaled graphic data, such as described above with respect to FIG. 2.

Method 400 then proceeds to step 410 with displaying the output image data on a device. In some aspects, the device may be a mobile device, such as a smartphone, tablet computer, smart wearable device. In some aspects, the device may be another type of electronic device including a display screen.

In some aspects, method 400 further includes extracting the text data from the input image data. For example, the text data may be extracted as described above with respect to step 306 in FIG. 3. In some aspects, extracting the text data from the input image data comprises performing optical character recognition on the input image data.

In some aspects of method 400, extracting the text data from the input image data comprises identifying the text data using a text identification model prior to performing optical character recognition on the input image data. For example, the model may determine whether text extraction is necessary, such as described above with respect to step 304 in FIG. 3.

In some aspects of method 400, extracting the text data from the input image data comprises receiving the text data from a scene generating engine configured to embed the text data in the input image data.

In some aspects of method 400, the extracted text data is stored in a vector data format. As described above, a vector data format beneficially enables scaling the text data arbitrarily without distortion.

In some aspects of method 400, generating output image data based on the scaled text data and the scaled graphic data comprises embedding the scaled text data into the scaled graphic data. For example, the scaled text data and the scaled graphic data may be embedded as described above with respect to embedding process 208 in FIG. 2.

In some aspects of method 400, generating scaled graphic data at the second resolution based on the graphic data at the first resolution includes processing the graphic data at the first resolution with a deep neural network model or a generative adversarial network model to generate the scaled graphic data at the second resolution.

In some aspects of method 400, the input image data comprises a multi-layer image. In other aspects, the image data comprises a raster image. As discussed, a raster image generally is an image in which image data is represented as a grid of pixels, with each pixel being assigned a color value. Generally, a raster image may be resized using various techniques that interpolate data in the resizing process, as opposed to vector images which may be infinitely resized without data interpolation due to vector images describing image data in terms of mathematical relationships.

### Example Processing Systems

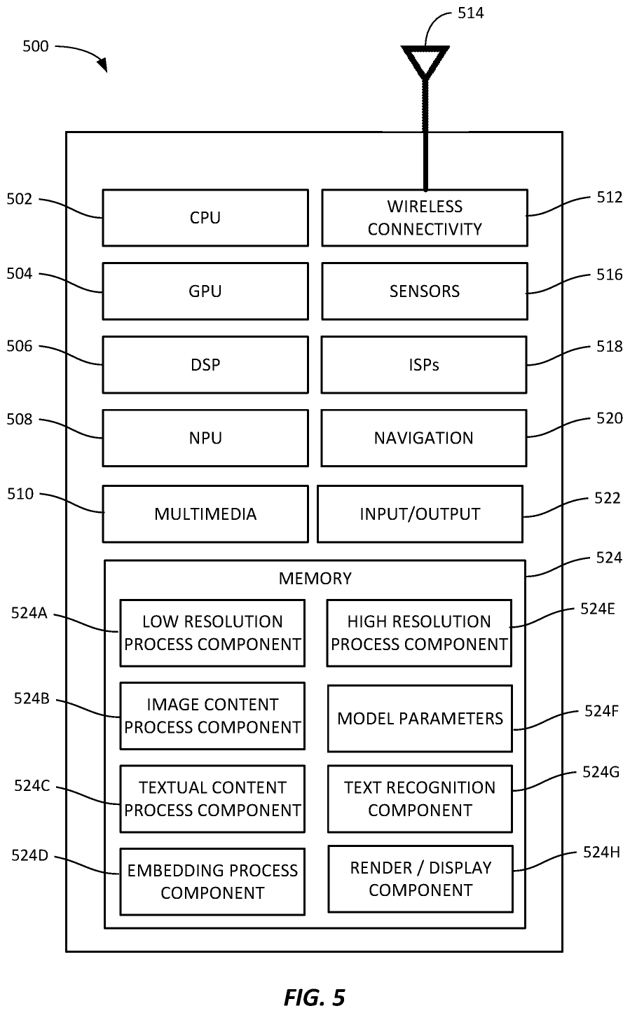

FIG. 5 depicts an example processing system 500 for performing the various aspects described herein, such as the methods described with respect to FIGS. 2-4.

Processing system 500 includes a central processing unit (CPU) 502, which in some examples may be a multi-core CPU. Instructions executed at the CPU 502 may be loaded, for example, from a program memory associated with the CPU 502 or may be loaded from a memory 524.

Processing system 500 also includes additional processing components, such as a graphics processing unit (GPU) 504, a digital signal processor (DSP) 506, a neural processing unit (NPU) 508, a multimedia processing unit 510, and a wireless connectivity component 512. Notably, these are just some examples, and others are possible.

An NPU, such as 508, is generally a specialized circuit configured for implementing all the necessary control and arithmetic logic for executing machine learning operations, such as operations for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 508, are configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 508 may be integrated as a part of one or more of CPU 502, GPU 504, and/or DSP 506.

In some examples, wireless connectivity component 512 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 512 is further connected to one or more antennas 514.

Processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS) as well as inertial positioning system components.

Processing system 500 may also include one or more input and/or output devices 522, such as screens, touch-sensitive surfaces (including touch-sensitive displays), physical buttons, speakers, microphones, and the like.

In some examples, one or more of the processors of processing system 500 may be based on an ARM or RISC-V instruction set.

Processing system 500 also includes memory 524, which is representative of one or more static and/or dynamic memories, such as a dynamic random access memory (DRAM), a flash-based static memory, and the like. In this example, memory 524 includes various computer-executable components, which may be executed by one or more of the aforementioned processors of processing system 500.

In particular, in this example, memory 524 includes low resolution process component 524A, image content process component 524B, textual content process component 524C, embedding component 524D, high resolution process component 524E, model parameters 524F, text recognition component 524G, and render and display component 524H. The depicted components, and others not depicted, may be configured to perform various aspects of the methods described herein.

Generally, processing system 500 and/or components thereof may be configured to perform the methods described herein.

### Example Clauses

Clause 1: A method, comprising: receiving input image data in a first resolution, wherein the input image data comprises text data and graphic data; generating scaled graphic data at a second resolution based on the graphic data at the first resolution and a first scaling factor, wherein the second resolution is based on the first resolution and the first scaling factor; generating scaled text data based on the text data and a second scaling factor; and generating output image data in the second resolution based on the scaled text data and the scaled graphic data.

Clause 2: The method of Clause 1, further comprising extracting the text data from the input image data.

Clause 3: The method of Clause 2, wherein extracting the text data from the input image data comprises performing optical character recognition on the input image data.

Clause 4: The method of Clause 3, wherein extracting the text data from the input image data comprises identifying the text data using a text identification model prior to performing optical character recognition on the input image data.

Clause 5: The method of any one of Clauses 2 through 4, wherein extracting the text data from the input image data comprises receiving the text data from a scene generating engine configured to embed the text data in the input image data.

Clause 6: The method of any one of Clauses 2 through 5, wherein the extracted text data is stored as vector data.

Clause 7: The method of any one of Clauses 1 through 6, wherein the second scaling factor is determined by a ratio of the second resolution to the first resolution.

Clause 8: The method of any one of Clauses 1 through 7, wherein the first resolution is lower than the second resolution.

Clause 9: The method of any one of Clauses 1 through 8, wherein generating scaled image data based on the scaled text data and the scaled graphic data comprises embedding the scaled text data into the scaled graphic data.

Clause 10: The method of any one of Clauses 1 through 9, wherein generating scaled graphic data at the second resolution based on the graphic data at the first resolution and the first scaling factor comprises processing the graphic data at the first resolution with a deep neural network model to generate the scaled graphic data at the second resolution.

Clause 11: The method of any one of Clauses 1 through 10, wherein generating scaled graphic data at the second resolution based on the graphic data at the first resolution and the first scaling factor comprises processing the graphic data at the first resolution with a generative adversarial network model to generate the scaled graphic data at the second resolution.

Clause 12: The method of any one of Clauses 1 through 11, wherein the input image data comprises a multi-layer image.

Clause 13: The method of any one of Clauses 1 through 12, wherein the input image data comprises a raster image.

Clause 14: The method of any one of Clauses 1 through 13, further comprising: displaying the scaled image data on a mobile device.

Clause 15: A processing system, comprising: a memory comprising computer-executable instructions; and a processor configured to execute the computer-executable instructions and cause the processing system to perform a method in accordance with any one of Clauses 1 through 14.

Clause 16: A non-transitory computer-readable medium comprising computer-executable instructions that, when executed by a processor of a processing system, cause the processing system to perform a method in accordance with any one of Clauses 1 through 14.

Clause 17: A computer program product embodied on a computer readable storage medium comprising code for performing a method in accordance with any one of Clauses 1 through 14.

Clause 18: A processing system, comprising means for performing a method in accordance with any one of Clauses 1 through 14.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving input image data in a first resolution, wherein the input image data comprises text data and graphic data;
generating scaled graphic data at a second resolution based on the graphic data at the first resolution and a first scaling factor, wherein the second resolution is based on the first resolution and the first scaling factor;
generating scaled text data based on the text data and a second scaling factor; and
generating output image data in the second resolution based on the scaled text data and the scaled graphic data.

2. The method of claim 1, further comprising extracting the text data from the input image data.

3. The method of claim 2, wherein extracting the text data from the input image data comprises performing optical character recognition on the input image data.

4. The method of claim 3, wherein extracting the text data from the input image data comprises identifying the text data using a text identification model prior to performing optical character recognition on the input image data.

5. The method of claim 2, wherein extracting the text data from the input image data comprises receiving the text data from a scene generating engine configured to embed the text data in the input image data.

6. The method of claim 2, wherein the extracted text data is stored as vector data.

7. The method of claim 1, wherein the second scaling factor is determined by a ratio of the second resolution to the first resolution.

8. The method of claim 1, wherein the first resolution is lower than the second resolution.

9. The method of claim 1, wherein generating scaled image data based on the scaled text data and the scaled graphic data comprises embedding the scaled text data into the scaled graphic data.

10. The method of claim 1, wherein generating scaled graphic data at the second resolution based on the graphic data at the first resolution and the first scaling factor comprises processing the graphic data at the first resolution with a deep neural network model to generate the scaled graphic data at the second resolution.

11. The method of claim 1, wherein generating scaled graphic data at the second resolution based on the graphic data at the first resolution and the first scaling factor comprises processing the graphic data at the first resolution with a generative adversarial network model to generate the scaled graphic data at the second resolution.

12. The method of claim 1, wherein the input image data comprises a multi-layer image.

13. The method of claim 1, wherein the input image data comprises a raster image.

14. The method of claim 1, further comprising: displaying the output image data on a mobile device.

15. A processing system, comprising:
a memory comprising computer-executable instructions; and
a processor configured to execute the computer-executable instructions and cause the processing system to:
receive input image data in a first resolution, wherein the input image data comprises text data and graphic data;
generate scaled graphic data at a second resolution based on the graphic data at the first resolution and a first scaling factor, wherein the second resolution is based on the first resolution and the first scaling factor;
generate scaled text data based on the text data and a second scaling factor; and
generate output image data in the second resolution based on the scaled text data and the scaled graphic data.

16. The processing system of claim 15, wherein the processor is further configured to extract the text data from the input image data.

17. The processing system of claim 16, wherein in order to extract the text data from the input image data, the processor is configured to perform optical character recognition on the input image data.

18. The processing system of claim 17, wherein in order to extract the text data from the input image data, the processor is configured to identify the text data using a text identification model prior to performing optical character recognition on the input image data.

19. The processing system of claim 16, wherein in order to extract the text data from the input image, the processor is configured to receive the text data from a scene generating engine configured to embed the text data in the input image data.

20. The processing system of claim 16, wherein the extracted text data is stored as vector data.

21. The processing system of claim 15, wherein the second scaling factor is determined by a ratio of the second resolution to the first resolution.

22. The processing system of claim 15, wherein the first resolution is lower than the second resolution.

23. The processing system of claim 15, wherein in order to generate scaled image data based on the scaled text data and the scaled graphic data, the processor is configured to embed the scaled text data into the scaled graphic data.

24. The processing system of claim 15, wherein in order to generate scaled graphic data at the second resolution based on the graphic data at the first resolution and the first scaling factor, the processor is configured to process the graphic data at the first resolution with a deep neural network model to generate the scaled graphic data at the second resolution.

25. The processing system of claim 15, wherein in order to generate scaled graphic data at the second resolution based on the graphic data at the first resolution and the first scaling factor, the processor is configured to process the graphic data at the first resolution with a generative adversarial network model to generate the scaled graphic data at the second resolution.

26. The processing system of claim 15, wherein the input image data comprises a multi-layer image.

27. The processing system of claim 15, wherein the input image data comprises a raster image.

28. The processing system of claim 15, wherein the processor is further configured to display the output image data on a mobile device.

29. A processing system, comprising:
means for receiving input image data in a first resolution, wherein the input image data comprises text data and graphic data;
means for generating scaled graphic data at a second resolution based on the graphic data at the first resolution and a first scaling factor, wherein the second resolution is based on the first resolution and the first scaling factor;
means for generating scaled text data based on the text data and a second scaling factor; and
means for generating output image data in the second resolution based on the scaled text data and the scaled graphic data.

30. A non-transitory computer-readable medium comprising computer-executable instructions that, when executed by a processor of a processing system, cause the processing system to:
receive input image data in a first resolution, wherein the input image data comprises text data and graphic data;
generate scaled graphic data at a second resolution based on the graphic data at the first resolution and a first scaling factor, wherein the second resolution is based on the first resolution and the first scaling factor;
generate scaled text data based on the text data and a second scaling factor; and
generate output image data in the second resolution based on the scaled text data and the scaled graphic data.
